(19) United States
(12) Patent Application Publication
(10) Pub. No.: US 2011/0264568 A1
(43) Pub. Date: Oct. 27, 2011

(54) SYSTEM AND METHOD FOR IN-ROOM DRINKING WATER SERVICE IN A HOTEL

(75) Inventors: Seung Jin Kim, Irvine, CA (US); Mincheol Kim, Tustin, CA (US)

(73) Assignee: CREVENT, INC., IRVINE, CA (US)

(21) Appl. No.: 13/130,052

(22) PCT Filed: Oct. 7, 2009
(86) PCT No.: PCT/US09/59912

§ 371 Date: May 19, 2011

Related U.S. Application Data
(60) Provisional application No. 61/103,443, filed on Oct. 7, 2008.

(51) Int. Cl. G06Q 10/00

(52) U.S. Cl. 705/30

(57) ABSTRACT

Disclosed is a system and method for providing an in-room drinking water service at a hotel. The system includes a plurality of drinking water dispensers provided in guest rooms of the hotel. The system further includes a computer program running on one or more computers of the hotel and configured to manage the in-room drinking water service. In the system and method, when providing of the service in a particular guest room is confirmed, the computer program coordinates charging a fee to an account of the particular guest room for the service.

### RELATED APPLICATION

This application claims the benefit of earlier filing date of U.S. Provisional Patent Application No. 61/103,443, filed Oct. 7, 2008. The disclosure of the provisional application is hereby incorporated herein by reference in its entirety.

### BACKGROUND

1. Field

The present disclosure relates to in-room water dispensing devices and services at hotels.

2. Discussion of related technology

Travelers typically drink bottled water in hotel rooms. This is at least partly because tap water in certain areas is not suitable for drinking or people think so, and also partly because travelers often do not have information about the quality of tap water. Regardless of the reasons, at the present time people tend to drink bottled water when traveling and particularly when staying at a hotel.

Some hotels provide complementary bottled water. However, many hotels sell bottled water in room; however, in-room water bottles are usually offered at a premium price. In the alternative, travelers can purchase water bottles from vending machines, hotel gift shops or nearby convenience stores; however, all of these options involve the inconvenience of going out of room to get water. Also, in all cases, water bottles sold in these contexts are typically in a size for one person's consumption. Moreover, humongous consumption of water bottle brings many hotels an environmental concern regarding the empty plastic bottles.

### SUMMARY

One aspect of the invention provides a system for providing an in-room drinking water service at a hotel. The system comprises: a plurality of drinking water dispensers provided in guest rooms of the hotel; a computer program running on one or more computers of the hotel and configured to manage the in-room drinking water service. In the system, when providing of the service in a particular guest room is confirmed, the computer program coordinates charging a fee to an account of the particular guest room for the service.

In the foregoing system, each of the dispensers may comprise a communication module configured to communicate with one or more computers of the hotel, wherein each of the dispensers may be configured to send information or data to the computer program and further configured to receive a command from the computer program. Providing the service in the particular guest room may be confirmed when the dispenser sends a notification to the computer program that the dispenser has dispensed drinking water. The communication module does not have a bandwidth to receive or send motion picture data. Each dispenser may comprise a communication module configured to communicate with one or more computers of the hotel, wherein each dispenser may be configured to transmit a notification to the computer program, notifying that the service has been initiated at the dispenser. Each dispenser may comprise a communication module configured to communicate with one or more computers of the hotel, wherein each dispenser may be configured to transmit a notification to the computer program, notifying that drinking water has been dispensed.

Still in the foregoing system, providing the service in the particular guest room may be confirmed when the dispenser sends a notification to the computer program that dispensing of drinking water has been enabled. Providing the service in the particular guest room may be confirmed when the hotel's employee unlocks the dispenser in the particular guest room. Each dispenser may comprise a locking module configured to disable or enable dispensing of drinking water from the dispenser. Each dispenser may be configured to receive a command from the computer program to lock or unlock the dispenser and further configured to lock or unlock at least one feature of the dispenser in accordance with the command. The computer program may be further configured to send a command to lock or unlock dispensing of drinking water from the dispenser. Each dispenser may comprise at least one selected from the group consisting of a water purification system, a replaceable bottle containing purified water, a water ionizing system and a pitcher with a replaceable filter.

Another aspect of the invention provides a method of providing an in-room drinking water service. The method comprises: providing a plurality of drinking water dispensers in guest rooms of the hotel; confirming that the in-room drinking water service is provided at a particular guest room; and subsequently, charging a fee to an account of the particular guest room for the service.

In the foregoing method, the fee may be in a fixed amount per night or per stay for dispensing an unlimited quantity of drinking water. The method may further comprise: offering the service during a reservation or check-in process; and receiving an instruction of a guest to purchase the service during the reservation or check-in process, wherein receiving the instruction confirms that the service may be provided at the particular room to which the guest may be assigned. Each of the dispensers may comprise a communication module configured to communicate with one or more computers of the hotel, wherein each of the dispensers may be configured to send information or data to the computer program and further configured to receive a command from the computer program. The method may further comprise: receiving, from the dispenser of the particular guest room, a notification that the dispenser has dispensed drinking water; and coordinating, by a computer program, to charge the fee to the account. Each dispenser may comprise a locking module configured to disable or enable dispensing of drinking water from the dispenser.

### BRIEF DESCRIPTION OF DRAWINGS

FIG. 1 illustrates a system for a hotel in-room drinking water service in accordance with an embodiment of the invention.

FIG. 2 illustrates an in-room drinking water dispenser for a hotel in-room drinking water service in accordance with an embodiment of the invention.

FIG. 3 is a flowchart of a procedure for a hotel in-room drinking water service in accordance with an embodiment of the invention.

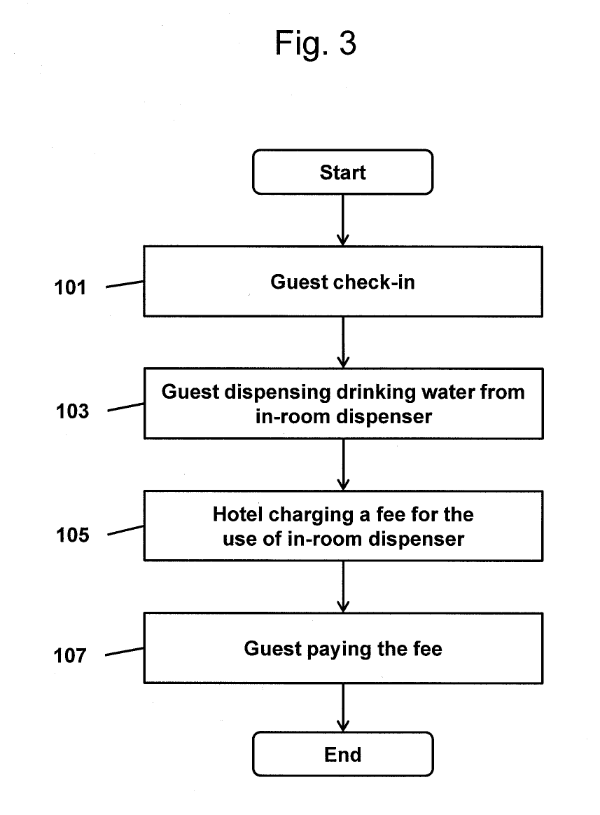

### DETAILED DESCRIPTION OF EMBODIMENTS

Various embodiments are described in detail. In the following description, numerous specific details, such as, for example, particular processes, materials, devices, parameters, conditions, structures and so forth, are presented to provide a thorough understanding of embodiments of the invention. One skilled in the relevant art will recognize, however, that the embodiments may be practiced without one or more of the specific details, or with other methods, components, etc. In other instances, structures or operations are not shown or described in detail to avoid obscuring the understanding of embodiments of the invention.

Throughout the disclosure, reference to “an embodiment” or “embodiments” means that a particular feature, structure, process, step, function, parameter, or characteristic described in connection with the embodiment(s) is included in at least one embodiment of the present invention. The phrases “in one embodiment” or “in embodiments” throughout this disclosure does not necessarily mean that the phrases all refer to the same embodiment(s). The particular feature, structure, process, step, function, parameter, or characteristic may be combined in any suitable manner in one or more embodiments.

### DEFINITIONS

In this disclosure, the term “hotel” refers to any accommodation services having a plurality of guest rooms. Such accommodation services include not only hotels or hotel services, but also other room rentals or such services including motels, inns, room and board services, bed and breakfast services, vacation rentals, managed time share services, etc. In the disclosure, any of hotel's actions are conducted by the hotel's computerized system, employee(s) and/or contractor(s).

In the disclosure, the term “guest” is used to refer to not only a single person who stays in the hotel, but also two or more people who stay together in a single guest room of the hotel. In the disclosure, any of the guest's actions are conducted by either a single guest or two or more of the guests.

In-Room Drinking Water Service

According to embodiments, a hotel provides an in-room drinking water service, in addition to supplying of tap water in hotel guest rooms. According to an embodiment of the in-room drinking water service, the hotel provides drinking water dispensers in its guest rooms and allows its guests to dispense drinking water from the in-room dispensers for their consumption. Then, the hotel charges a fee for the use of the dispenser to its guests. The in-room drinking water service allows hotel guests to drink high quality water in their guest rooms without having to purchase bottled water.

In-Room Drinking Water Dispensers

In one embodiment, the in-room drinking water dispenser includes a water purification system that receives a supply of water and processes to remove impurities. The water purification system is typically connected to a water conduit of the hotel to receive the supply of water. To remove impurities from the supplied water, the water purifier may use one or more technologies using, but not limited thereto, micro-filtration membrane, ultra-filtration membrane, reverse-osmosis membrane, etc. This dispenser dispenses water purified in the dispenser itself One skilled in the relevant art will understand details of such a water purification system and any alternatives or equivalents.

In other embodiment, the in-room drinking water dispenser includes a pre-purified water container containing pre-purified water for dispensing. In these embodiments, the dispenser typically is not connected to any water conduit or supply line of the hotel for its operation. Typically the container is a replaceable water bottle to contain an amount of pre-purified water, e.g., 1, 2, 3, 4, 5, 6, 7, 8, 9, 10 gallons. One skilled in the relevant art will understand details of such pre-purified water dispensers and any alternatives or equivalents.

In other embodiments, the in-room drinking water dispenser includes a water ionizing or alkalizing system that separates some of ions or charged minerals based on their electrical polarity. In these embodiments, the dispenser dispenses ionized water or alkaline water. The water ionizing or alkalizing system may be connected to the hotel's water supply conduit to receive a supply of water. In some of these embodiments, the dispenser may also include water purifications system. In some other embodiments, the dispenser with a water ionizing system may have a replaceable water container that is similar to the pre-purified water container. One skilled in the relevant art will understand details of such a water ionizing or alkalizing system any alternatives or equivalents.

In other embodiments, the in-room drinking water dispenser includes a water container having an unfiltered water compartment, a filtered water compartment and the filter that is placed in a channel connecting between the two compartments. In these embodiments, unfiltered water or tap water is filled in the unfiltered water compartment, and the unfiltered water is filtered by the filter as it flows toward the filtered water compartment through the channel. In one of these embodiments, the water container has a pitcher like configuration and is portable by hand. In some of these embodiments, the filter can be installed in the channel and removed therefrom without use of any tools. The filter may be provided for users or hotel guests to install or place in the channel. One skilled in the relevant art will understand details of such dispensers and any alternatives or equivalents.

In the foregoing and any other embodiments, the in-room drinking water dispenser may perform one or more of the functions and features including cooling, warming or heating the water before dispensing. In some embodiments, the dispenser may include an icemaker that makes ice with the water to be dispensed. One skilled in the relevant art will understand details of the foregoing features and any alternatives or equivalents.

Additional Features of In-Room Drinking Water Dispensers

In various embodiments, the in-room drinking water dispenser may have one or more features that can facilitate the in-room drinking water service and its procedures. These features include, but not limited to, weighing water contained in a water container, measuring or calculating the weight of water that is being dispensed or has been dispensed for a period, measuring or calculating the volume of water that is being dispensed or has been dispensed for a period, communicating with the hotel's other system or devices, locking or unlocking the dispenser, an information display, a user friendly interface, etc.

Weighing Water and Sensing Water Flow

In embodiments, the in-room drinking water dispenser includes a module or device for weighing water contained in a water container of the dispenser. In one embodiment, the dispenser includes a module or device for sensing the level of water contained in a water container of the dispenser. In one embodiment, the dispenser includes a module or device for sensing a flow of water in a pipe, conduit or faucet of the dispenser. One skilled in the relevant art will understand details of such modules and devices for implementing them in the dispenser.

Determining Amount of Water Dispensed

In embodiments, the in-room drinking water dispenser includes a module or device for determining and/or calculating the amount of water that is being dispensed from the dispenser. In one embodiment, the dispenser includes a module or device that determines or calculates the amount of water that is dispensed for a period. Here, the amount of dispensed water may be presented in weight or volume. In implementing such a module or device, the dispenser may need to include a module or device for measuring or sensing weight or water flow. In implementing such a module or device, the dispenser may include one or more processors and one or more electronic memories. One skilled in the relevant art will understand details of such modules and devices for implementing them in the dispenser.

Communicating with Other System or Device

In embodiments, the in-room drinking water dispenser includes a module or device for communicating with one or more other devices, computers, apparatus and systems. In one embodiment, the communication module includes a telephone modem for sending and receiving data via a telephone line. In one embodiment, the communication module includes a broadband modem for sending and receiving data via a broadband data cable such as an Ethernet cable. In one embodiment, the communication module includes a wireless module that can communicate with a wireless router, a Bluetooth device or other short distance or long distance wireless devices.

In embodiments, the communication module is connected to at least one computer of the hotel's computer system. The communication module may be connected to the hotel's computer system via a wired network or wireless network provided in the hotel. One skilled in the relevant art will understand different forms and methods of connection and will be able to develop an appropriate form of connection based on the purpose and extent of the communication between the dispenser and the hotel's computer or computer system.

In embodiments, the communication module does not receive multimedia data from the hotel's computer system or any other computing devices of the hotel. In embodiments, not only the communication module but also other components of the dispenser have the capacity to process the signals of multimedia data such as motion pictures, image files, music, etc. In embodiments, on the other hand, the communication module is of the capacity to send or receive information, data or commands that are sufficient to manage the operation of the in-room drinking water service. Further, in embodiments, any information processing modules of the dispenser such as a processor are also of the capacity to generate command signals and notification signals, and are not of the capacity to process multimedia data.

In one embodiment, the communication module communicates with the hotel's operation system and software. In operation, the communication module may send information relating to the status and operation of the dispenser to the hotel operation system and software. For example, the communication module may send information indicative of operation errors, maintenance needs, etc. On the other hand the communication module may receive commands and/or information relating to the service to guests staying in the guest room where the dispenser is located. For example, the communication module may receive a command of initiating the service, information about how many days the service is to be rendered, a command of locking or unlocking the dispenser, etc. One skilled in the relevant art will understand details of data communication between the between the dispenser and the hotel's computer or computer system.

In one embodiment, the communication module communicates with one or more guest remote control devices for operating the dispenser by hotel guests. The guest remote control devices have another user interface configured to allow user to enter commands, selections or codes. The guest remote control devices may include an information display panel.

In one embodiment, the communication module further communicates with one or more handheld employee-only devices to receive information or data from the dispenser for checking operation statuses or maintenance needs of the dispenser. The employee-only devices may be handheld computer or industrial PDAs, which typically have a data input device and/or a display panel. The employee-only devices may communicate with the hotels' computing network to forward data from the dispenser to the software controlling operation of the dispenser. The employee-only devices may communicate with the communication module of the dispenser from within or outside the guest room via wired or wireless connection.

Locking and Unlocking Dispenser

In embodiments, the in-room drinking water dispenser includes a lock or a module for selectively locking and unlocking the device. In some embodiments of the in-room drinking water service, the hotel may need to lock the dispenser to block the guests from using it, although in other embodiments such locking may be unnecessary. In one embodiment, the lock or locking module is configured to mechanically block a person's access to a dispenser faucet. In one embodiment, the locking module is configured to mechanically block a person's access to user input panel of the dispenser. For example, the locking module may include a door or cover that covers the dispenser's faucet area or user input panel. One skilled in the relevant art will understand details of such a locking module and will be able to implement such a locking device in the dispenser.

In some embodiments, the lock or locking module includes an electrical circuit configured to disable at least part of operation of the dispenser. In one embodiment, the lock or locking module is configured to disable a water pump of the dispenser. In one embodiment, the lock or locking module is configured to disable user input panel, user input buttons or user interface panel. In one embodiment, the lock or locking module is configured to disable a valve of the dispenser. In one embodiment, the lock or locking module is configured to lock a vale of the dispenser. One skilled in the relevant art will understand details of such a locking module and will be able to implement such a locking device in the dispenser.

In some embodiment, the lock or locking module uses a mechanical key, a magnetic key, an electromagnetic key, etc. to lock or unlock the dispenser. In one embodiment, locking and unlocking may be performed only at the dispenser. In another embodiment, locking and unlocking may be performed remotely. In such embodiment, the locking and unlocking may be performed at a terminal connected to the hotel's computer system. One skilled in the relevant art will understand details of such a locking module and will be able to implement any such locking devices in the dispenser.

Card Reader

In some embodiments, the in-room drinking water dispenser includes a card reading module or card reader for reading information stored in a card. In embodiments, the card is one ore more of a guest room key card, a credit card of a guest, a debit card of a guest, and any other cards that can identify the holder of the card. In embodiments, the card reader or card reading module is configured to read information saved in the card using any available technology. In one embodiment, guests of the room slide the card relative to the card reader, contact the card with the card reader, move the card close to the card reader, and/or take any appropriate actions. In some embodiments, the action of the guests, when appropriate, makes the card reader read information saved in the card, by which to lock or unlock the dispenser. Also, in some embodiments, the action of the guests, when appropriate, makes the card reader read information saved in the card, by which to initiate or terminate, to activate or deactivate, and/or to enable or disable one or more functions or features of the dispenser.

User Interface

In some embodiments, the in-room drinking water dispenser has a user interface including a user input panel. In one embodiment, the user input panel includes one or more buttons to input user's selection such as hot water, cold water, ambient water, ice dispensing, alkalized water, etc. In one embodiment, the user input panel includes one or more buttons to input user's command, such as dispensing water, locking or unlocking the dispenser, locking or unlocking hot water feature. In one embodiment, the one or more buttons of the user input panel include a plurality of number input keys for entering numerical codes and/or commands. In another embodiment, the one or more buttons of the user input panel include alphanumerical input keys for entering alphanumerical codes and/or commands.

In one embodiment, the user interface includes an information display panel for displaying the status of dispenser operation. For example, the display may display temperature of water, a remaining amount of water available for dispensing, etc. The information display panel can display any other information available in the dispenser or any additional information that is supplied to the dispenser from the hotel operation management system.

Providing In-Room Drinking Water Dispensers

In order to offer the in-room drinking water service according to embodiments, the hotel provides in-room drinking water dispensers in one or more guest rooms. In one embodiment, the hotel provides a drinking water dispenser in every guest room to provide the in-room drinking water service to all its guests. In another embodiment, the hotel provides the drinking water dispenser only in some of its guest rooms. In one embodiment, the in-room drinking water dispenser is pre-installed or provided in guest rooms before the guest has arrived in the assigned room. In another embodiment, the in-room drinking water dispenser is installed or provided at the guest's request or ordering the service after the guest has arrived in the assigned room.

In embodiments, the dispenser is pre-installed or provided at a predetermined location of the guest room. In one embodiment, the dispenser is placed within the guest room but not in its bathroom area. In one embodiment, the dispenser is placed in the bathroom area of the guest room. In one embodiment, the dispenser includes a water processing module, which is located in the bathroom area of the guest room and the user interface of the dispenser is placed outside the bathroom area. In one embodiment, the dispenser or part thereof is placed in a bay formed in an internal wall of the guestroom.

In-Room Drinking Water Service System

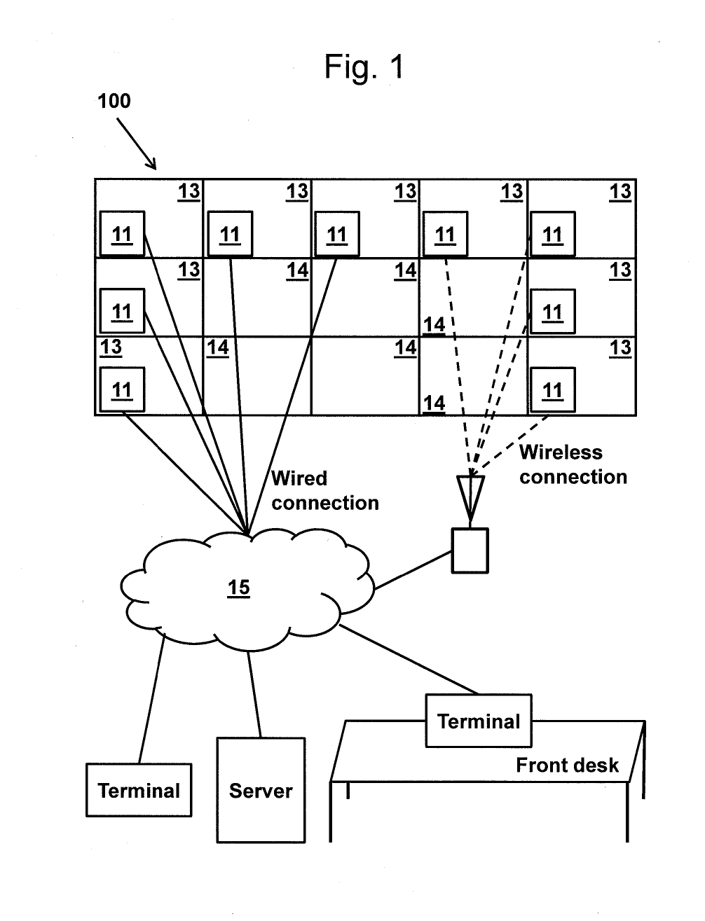

In one embodiment, the hotel has a system for in-room drinking water service. Referring to the illustrated embodiment of FIG. 1, the system 100 includes a plurality of in-room drinking water dispensers 11 provided in guest rooms 13. In some other guest rooms 14, drinking water dispenser 11 is not provided. The in-room drinking water dispensers 1 are connected to a computing network 15. Some of the dispensers 11 are wirelessly connected to the network 15 while others are connected the network 15 via wires. The system 100 includes one or more computer terminals and servers.

The system 100 further includes in-room drinking water service software running on at least one of the computer servers, which communicates with the plurality of in-room drinking water dispensers 11. The in-room drinking water service software monitors, manages or controls operations of the in-room drinking water dispenses 11, including the actions of locking or unlocking dispensers or functions thereof, scheduling maintenance of dispensers, receiving error reports, etc. In one embodiment, the in-room drinking water service software is a stand alone computer program that communicates and thereby is integrated with the hotel operation software. In another embodiment, the in-room drinking water service software is a module of the hotel operation software. In these embodiments, for instance when a guest dispenses drinking water from the dispenser 11, the in-room drinking water service software updates the hotel operation management system about the guest's use of the dispenser so that the hotel operation management system can charge the guest for the use of the dispenser.

Exemplary Dispensers

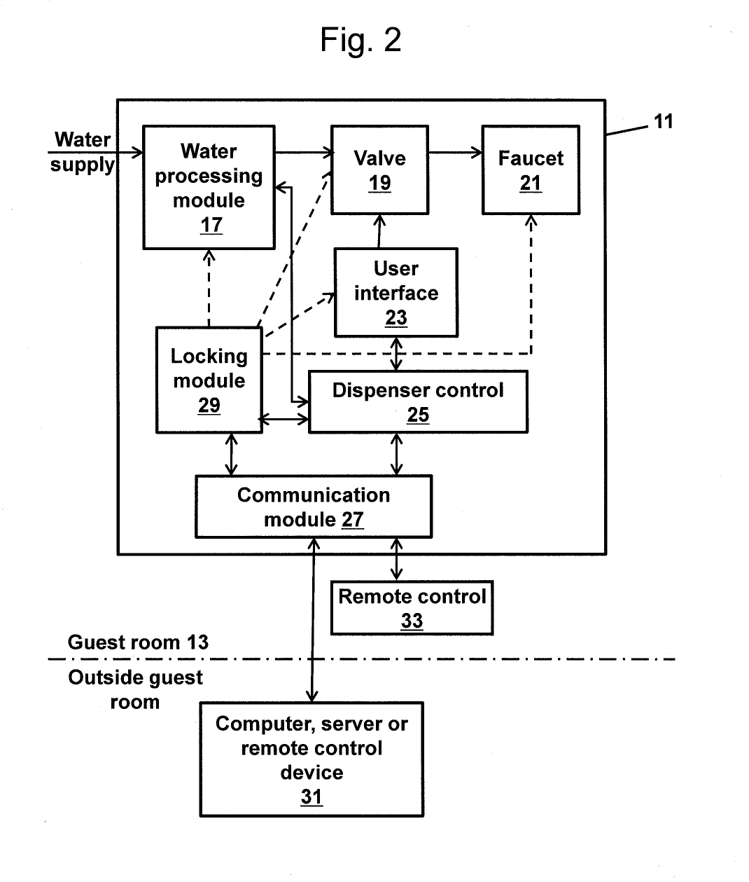

FIG. 2A illustrates an in-room drinking water dispenser 11 provided in the guest room 13 in accordance with an embodiment. In the illustrated embodiment, the dispenser 11 includes a water processing module 17 that receives a supply of water from outside the dispenser 11 and processes the water. The water processing module 17 includes, for example, water purification system. The processed water is supplied to valve 19 and then to facet 21 of the dispenser. The valve 19 controls and/or regulates the flow of water from the water processing module 17 to the faucet 21. User interface 23 receives an input of user or hotel guest, which may go to control the valve 19. In addition or in the alternative, the user input from the user interface 23 goes to dispenser control 25, which may include at least one of a processor and a memory. As indicated using dotted lines, locking module 29 may lock/unlock, disable/enable, deactivate/activate one or more components of the dispenser 11 such as the water processing module 17, valve 19, faucet 21 and user interface 23.

The dispenser control 25 may send information to the user interface 23 to display on a display panel of the user interface 23. The dispenser control 25 further communicates with the water processing module 17, user interface 23 and locking module 29. The dispenser control 25 sends control commands to the water processing module 17 and locking module 29, and receives status information from these modules 17 and 29. The dispenser control 25 may send control commands to the communication module 25 and may further send information and/or data to send to devices 31, 33 outside the dispenser 11. In one embodiment, the device 31 is a computer, server, a remote control device, or an employ-only handheld device located outside the guest room 13. In one embodiment, the device 33 is a remote control device located within the guest room 13 or an employee-only device. The communication module 27 receives commands, information and/or data from the outside and sends them to the dispenser control 25 and/or to the locking module 29. Locking and unlocking commands from the outside may directly go to the locking module 29 from the communication module 27. In the alternative, locking and unlocking commands may go to the locking module 29 via the dispenser control 25.

Procedures

Referring FIG. 2, a general procedure of the in-room drinking water service in accordance with an embodiment is now described. At step 101, a guest checks in at a hotel that provides in-room drinking water service according to an embodiment. The hotel assigns a guest room having an in-room drinking water dispenser to the guest. Then, the guest goes to the assigned guest room. During the stay, at step 103, the guest dispenses drinking water from the in-room dispenser. At step 105, the hotel charges a fee to the guest for the use of the in-room dispenser at or before checking out. Then at step 107, the guest pays the fee.

Guest Check-In

During the guest check-in 101, the hotel, e.g., front desk employee, may provide information about the in-room drinking water service to the guest and offer the guest to purchase the service. In response, the guest may decide to purchase the service during check-in 101. Then, the hotel assigns the guest to a guest room 13 with an in-room drinking water dispenser 11 and processes the guest's purchase of the service such that a proper charge is made to the guest's account.

In some instances, the guest may decline the in-room drinking water service. In other instances, the guest may simply want to defer the decision as to purchasing the service during check-in 101 to a later time. Unless the guest prefers a guest room 14 that does not have in-room drinking water dispenser 11, the hotel may still assign the guest to a guest room 13 that has an in-room drinking water dispenser 11. Then, the hotel may provide the information that the in-room drinking water service can be purchased and activated any time during the guest's stay with the hotel. The hotel may provide information about how to purchase or initiate the in-room drinking water service. In one embodiment, the service is initiated by requesting the hotel activate the service. In another embodiment, the service is initiated by simply dispensing water from the dispenser.

In some embodiments, the foregoing processes for offering the service and providing information about the availability of the service can occur during reservation for a hotel room to the extent possible. In one embodiment, the reservation is made on-line. In another embodiment, the reservation is made telephonically with the hotel. In another embodiment, the reservation is made via a travel agency.

Unlocking of Dispenser

In some embodiments, the dispenser 11 has locking and unlocking features. Also, in some embodiments, the in-room drinking water service can be initiated by activating or unlocking the dispenser 11, although not limited thereto. In some embodiments where the dispenser 11 is locked, the hotel unlocks or activates the dispenser 11 at the guest's request during or after the guest's check-in. In one embodiment, unlocking can be performed remotely from a terminal connected to the dispenser 11 via hotel's computing network 15. In another embodiment, the hotel sends an employee to the guest room to unlock or activate the dispenser 11.

In some other embodiments where the dispenser 11 is locked, the hotel provides the guest with a key for unlocking the dispenser 11 at the guest's request for the service during or after check-in. In one embodiment, the hotel provides the guest with a physical key to unlock or activate the dispenser 11. In another embodiment, the hotel provides the guest with a code key for inputting via the user interface 23 to unlocking the dispenser 11. In these embodiments, the guest unlocks or activates the dispenser 11 using the provided key.

Locking of Dispenser

In some embodiments, the dispenser 11 is locked when or after a period of the service has expired. In one embodiment, the hotel sends an employee to the guest's room 13 and locks the dispenser 11 after expiration of the service. In one embodiment, a hotel employee remotely controls the dispenser 11 to lock it after expiration of the service. In another embodiment, the in-room drinking water service software controls locking of the dispenser 11 after expiration of the service period for the next service period or for next guests. In other embodiments, whether the dispenser 11 has the locking/unlocking feature, the hotel or the software does not lock the dispenser 11 even after expiration of the service period.

Service Period

In one embodiment, the in-room drinking water service begins once the guest has checked in the hotel. In one embodiment, the service begins without activation or initiation by the hotel. In one embodiment, the service begins as the guest first dispenses drinking water from the in-room dispenser 11. In one embodiment, the service begins as the guest activates, disable or unlocks the dispenser 11. In one embodiment, the service begins once the hotel activates, enables or unlocks the dispenser 11 in response to a request by the guest. In embodiments where the service ends before the guest's check-out, the service may resume in any one of the foregoing different ways.

In one embodiment, the in-room drinking water service ends when the hotel deactivates disables or locks the dispenser 11 in response to a request by the guest. In one embodiment, the service ends as the guest deactivates, disables or locks the dispenser. In one embodiment, the service ends when a predetermined period has passed from the beginning of the service. Here, the predetermined period may be one day, 24 hours, or the number of days of the guest's stay. In one embodiment, the service ends when a preset time has reached. Here, the preset time is, for example, the hotel's predetermined and/or announced time for ending the service, the hotel's predetermined and/or announced time for regular check-out. In one embodiment, the service ends as the guest processes for check-out.

Dispensing of Drinking Water

In case the dispenser 11 is locked, the guest can dispense drinking water only after unlocking or activating the in-room drinking water dispenser 11. In case the dispenser 11 is not locked and is ready for use anytime, the guest may simply dispense drinking water from the dispenser 11. In one embodiment, the service may begin when the guest first uses the dispenser 11, although not limited thereto.

Dispensing Quantity per Service Period

In one embodiment, the guest may dispense an unlimited amount of drinking water during the service. In another embodiment, the guest may dispense the drinking water up to a predetermined amount per day. In another embodiment, the guest may dispense the drinking water up to a predetermined amount for a series of days, a service period longer than one day. In another embodiment, the guest may dispense an unlimited amount of drinking water for a specific length of time that is substantially shorter than a day.

Fees for In-Room Drinking Water Service

In one embodiment, the hotel charges a flat fee for the service per day or per night. In another embodiment, the hotel charges a flat fee per stay, which is one or more nights. In one embodiment, the hotel has a fee schedule, providing different charge amounts for different lengths of stay. For example, $7 is charged for a one night stay, $13 is charged for a two night stay, $19 is charged for a three night stay, $25 is charged for a four night stay, and $35 is charged for a seven night stay. In the foregoing embodiments, the flat fee may vary based on the number of persons staying in the guest room. In such embodiments, the more the number of people, the higher the flat fee per night or per stay.

In one embodiment, the hotel charges a flat fee for the use of the dispenser per night or per stay with a limit or cap of the amount of consumption or dispensing of drinking water. In this embodiment, the flat fee covers the consumption or dispensing up to the limit set per night or per stay. The hotel may set the limit arbitrarily such as one gallon per night, two gallons per night, one liter per night, two liters per night, three liters per night, four liters per night, five liters per night, although not limited thereto. In this embodiment, the hotel may charge an additional fee for any additional dispensing or consumption of drinking water. The additional charge may be a fixed amount. Alternatively, the additional charge may be calculated based on the amount of additional consumption or dispensing.

In another embodiment, the hotel charges a fee that is calculated based on the amount of consumption or dispensing. In this embodiment, the amount of consumption or dispensing is monitored in volume or weight and reported to the hotel operation for the calculation of the fee.

Charging Service Fees

In embodiments, the fee(s) for the in-room drinking water service is charged upon confirming that the service is initiated, provided or completed. In one embodiment, the fee for the service is charged to the guest's account when the guest orders the service or when the order has been processed. In another embodiment where the dispenser 11 is pre-locked, the fee is charged to the guest's account when the dispenser 11 is unlocked by the hotel or the guest. In another embodiment, the fee is charged to the guest's account when the guest initiates, activates or enables the dispenser 11 for the service. In another embodiment, the fee is charged to the guest's account when the guest first uses the dispenser 11. In another embodiment, the fee is charged to the guest's account at the time of guest room reservation or check-in at the hotel. In another embodiment, the fee is charged when the service begins. In another embodiment, the fee is charged when the service ends. In embodiments, the fee(s) charged to the guest's account is paid during the guest's check-out.

Detecting and Confirming Use of Dispenser

In some embodiments, the use of the dispenser 11 (dispensing water from the dispenser 11) needs to be detected for the purpose of charging the service fee. In one embodiment, the dispenser 11 includes a flow sensor (not illustrated) in the conduit between the water processing module 17 and the faucet 21. The flow sensor detects any flow of drinking water in the conduit and therefore detects the use of the dispenser 11. In one embodiment, upon detecting flow of water, the flow sensor sends a signal or report to the dispenser control 25.

In one embodiment, the dispenser 11 includes a lever (not illustrated) to operate the valve 19 for flowing the drinking water through the faucet 21. In one embodiment, the dispenser 11 further includes a lever sensor (not illustrated) for detecting the movement or position of the lever. In one embodiment, upon detecting the movement of the lever or a particular position of the lever, the lever sensor sends a signal or report to the dispenser control 25.

In one embodiment, the dispenser 11 includes a button (not illustrated) to operate the valve 19 for flowing the drinking water through the faucet 21. In one embodiment, the dispenser 11 further includes a button sensor (not illustrated) for detecting a particular position of the button or touching of the button by a human body. In one embodiment, upon detecting touching by a human body or the particular position, the button sensor sends a signal or report to the dispenser control 25.

In the foregoing embodiments, the dispenser control 25 receives a signal or report and confirms that the dispenser 11 has been used. Then the dispenser control 25 causes to generate a notification that notifies the use of the dispenser 11. In one embodiment, the notification is sent, the via the communication module 27, to the in-room drinking water service software or the hotel's operation management software for proper fee charging process. In one embodiment, the notification is received using an employ-only device via the communication module 27.

In another embodiment, the notification includes turning on an LED light, which can be confirmed by the hotel's employee such as housekeeping service persons. In another embodiment, the notification includes displaying information indicating that the dispenser 11 has been used, which can be confirmed by the guest and also by hotel's employee such as housekeeping service persons. Once confirming the use of the dispenser, the hotel employee(s) resets the notification such as turning off the light or removing the information displayed.

In one embodiment, the dispenser 11 includes a weighing scale (not illustrated) that weighs a purified water bottle. In one embodiment, the weighing scale sends the weight of the purified water bottle to the dispenser control 25. The dispenser control 25 then processes weights from the weighing scale and determines whether the weight of the purified water bottle has been decreased. In one embodiment, upon determining that the weight has decreased, the dispenser control 25 confirms that the dispenser 11 has been used and generates a notification that notifies the use of the dispenser 11. The notification is provided to the hotel's employee or its software in the same manner as described above.

In one embodiment, the dispenser 11 includes a breakable seal, breakable string or any equivalent thereof, which is placed on a button or lever of the dispenser 11 such that the seal, string or equivalent must be broken or torn to properly operate the button or lever. In one embodiment, the breakable seal, breakable string or any equivalent thereof can be easily broken or torn without a tool. In the embodiment, the button or lever is configured to operate the valve to flow or stop drinking water through the faucet 21. In this embodiment, when the guest pushes the button or moves the lever to dispense drinking water, the seal, string or equivalent is to be broken or torn. Thus, the hotel employee such as a housekeeping service person can check the status of the seal, string or equivalent and confirm as to whether the dispenser 11 has been used by the guest. In one embodiment, upon confirming the hotel employee may install or place a new seal, string or equivalent on the button or lever of the dispenser 11.

Alternative Method of Charging Fees

In one embodiment, the hotel charges a higher room rate for the guest room with a dispenser than other similar or identical rooms without a dispenser. In this embodiment, the fee for the in-room drinking water service is not charged to the guest's account as an independent item.

In another embodiment, the in-room drinking water dispenser includes a payment transaction interface, which is configured to perform at least one action selected from the group consisting of receiving a bill, receiving a coin, receiving a personal or corporate check, receiving credit card information for charging to the credit card, receiving debit card information for charging to an account associated with the debit card, receiving a phone number for charging to an account associated with the telephone number, receiving a gift certificate number for charging to the gift certificate, and receiving a mileage or points program account for deducting mileage from the mileage or points program account.

Providing Take-out Bottles

In one embodiment, in each guest room where the dispenser 11 is provided, the hotel provides one or more empty bottles or containers for taking the drinking water out of the dispenser 11 out of the guest room. In one embodiment, the take-out bottles or water containers are placed next to the dispenser 11. In one embodiment, the take-out bottles or water containers are provided free of charge. In one embodiment, the take-out bottles or water containers are offered at a price.

What is claimed is:

1. A system for providing an in-room drinking water service at a hotel, the system comprising:
a plurality of drinking water dispensers provided in guest rooms of the hotel; and
a computer program running on one or more computers of the hotel and configured to manage the in-room drinking water service,
wherein when providing of the service in a particular guest room is confirmed, the computer program coordinates charging a fee to an account of the particular guest room for the service.

2. The system of claim 1, wherein each of the dispensers comprises a communication module configured to communicate with one or more computers of the hotel, wherein each of the dispensers is configured to send information or data to the computer program and further configured to receive a command from the computer program.

3. The system of claim 2, wherein providing the service in the particular guest room is confirmed when the dispenser sends a notification to the computer program that the dispenser has dispensed drinking water.

4. The system of claim 1, wherein the communication module does not have a bandwidth to receive or send motion picture data.

5. The system of claim 1, wherein each dispenser comprises a communication module configured to communicate with one or more computers of the hotel, wherein each dispenser is configured to transmit a notification to the computer program, notifying that the service has been initiated at the dispenser.

6. The system of claim 1, wherein each dispenser comprises a communication module configured to communicate with one or more computers of the hotel, wherein each dispenser is configured to transmit a notification to the computer program, notifying that drinking water has been dispensed.

7. The system of claim 1, wherein providing the service in the particular guest room is confirmed when the dispenser sends a notification to the computer program that dispensing of drinking water has been enabled.

8. The system of claim 1, wherein providing the service in the particular guest room is confirmed when the hotel's employee unlocks the dispenser in the particular guest room.

9. The system of claim 1, wherein each dispenser comprises a locking module configured to disable or enable dispensing of drinking water from the dispenser.

10. The system of claim 9, wherein each dispenser is configured to receive a command from the computer program to lock or unlock the dispenser and further configured to lock or unlock at least one feature of the dispenser in accordance with the command.

11. The system of claim 9, wherein the computer program is further configured to send a command to lock or unlock dispensing of drinking water from the dispenser.

12. The system of claim 1, wherein each dispenser comprises at least one selected from the group consisting of a water purification system, a replaceable bottle containing purified water, a water ionizing system and a pitcher with a replaceable filter.

13. A method of providing an in-room drinking water service, the method comprising:
providing a plurality of drinking water dispensers in guest rooms of the hotel;
confirming that the in-room drinking water service is provided at a particular guest room; and
subsequently, charging a fee to an account of the particular guest room for the service.

14. The method of claim 13, wherein the fee is in a fixed amount per night or per stay for dispensing an unlimited quantity of drinking water.

15. The method of claim 13, further comprising:
offering the service during a reservation or check-in process; and
receiving an instruction of a guest to purchase the service during the reservation or check-in process, wherein receiving the instruction confirms that the service is provided at the particular room to which the guest is assigned.

16. The method of claim 13, wherein each of the dispensers comprises a communication module configured to communicate with one or more computers of the hotel, wherein each of the dispensers is configured to send information or data to the computer program and further configured to receive a command from the computer program.

17. The method of claim 16, further comprising:
receiving, from the dispenser of the particular guest room, a notification that the dispenser has dispensed drinking water; and
coordinating, by a computer program, to charge the fee to the account.

18. The method of claim 13, wherein each dispenser comprises a locking module configured to disable or enable dispensing of drinking water from the dispenser.
